(19) United States
(12) Patent Application Publication
(10) Pub. No.: US 2026/0046869 A1
(43) Pub. Date: Feb. 12, 2026

(54) Methods And Apparatus For On-Off Control Of Data Forwarding Operation In Mobile Communications

(71) Applicant: MediaTek Inc., Hsinchu City (TW)

(72) Inventors: Kuan-Yuan Chen, Hsinchu City (TW); Lung-Sheng Tsai, Hsinchu City (TW)

(21) Appl. No.: 19/292,356

(22) Filed: Aug. 6, 2025

Related U.S. Application Data
(60) Provisional application No. 63/681,953, filed on Aug. 12, 2024.

(51) Int. Cl. H04W 72/20; H04L 5/00; H04W 72/0453

(52) U.S. Cl. CPC H04W 72/20; H04L 5/0051; H04W 72/0453

(57) ABSTRACT

Methods and apparatus pertaining to on-off control of data forwarding operations in mobile communications are described. An apparatus transmits at least one configuration parameter to a collaborative device. The configuration parameter is transmitted to the collaborative device to determine a time to activate a data forwarding operation of the collaborative device. The apparatus further transmits a first RF signal in a first frequency band to a network node according to the configuration parameter and transmits a second RF signal in a second frequency band to the collaborative device in an event that the data forwarding operation of the collaborative device is activated. The first RF signal and the second RF signal carry uplink data to be transmitted to the network node, and the first frequency band is different from the second frequency band.

### CROSS REFERENCE TO RELATED PATENT APPLICATION(S)

The present disclosure is part of a non-provisional application claiming the priority benefit of U.S. Patent Application No. 63/681,953, filed 12 Aug. 2024, the content of which herein being incorporated by reference in its entirety.

### TECHNICAL FIELD

The present disclosure is generally related to mobile communications and, more particularly, to on-off control of data forwarding operation of a collaborative user equipment (UE) in mobile communications.

### BACKGROUND

Unless otherwise indicated herein, approaches described in this section are not prior art to the claims listed below and are not admitted as prior art by inclusion in this section.

Multiple-input multiple-output (MIMO) is an antenna technology for wireless communications in which multiple antennas are used at both the source (e.g., transmitter) and the destination (e.g., receiver). The antennas at each end of the communication apparatus are combined to minimize errors, optimize data throughput and improve the capacity of radio transmissions by enabling data to travel over many signal paths at the same time. Creating multiple versions of the same signal provides more opportunities for the data to reach the receiving antenna without being affected by fading, which improves the signal-to-noise ratio and error rate. By boosting the capability of radio frequency (RF) systems, MIMO technology can create a more stable connection, less congestion and high data throughput.

In a mobile communication system, if a UE could support a high number of MIMO layers, it could have diversity gain or multiplexing gain. However, the number of available MIMO layers is limited by channel quality between a network node (e.g., the base station (BS) or a next generation Node-B (gNB)) and the UE. In addition, hardware and/or software limitations and power limitations of the UE could also limit the MIMO capability of the UE. Therefore, if there is another UE-controlled device (e.g., a collaborative UE, a relay, or a repeater that may act as an external antenna panel wirelessly connected to the UE) that could help forwarding the data/signaling via another frequency, it could increase the effective number of MIMO layer and boost the MIMO performance significantly.

To support data forwarding, the Uu interface data in frequency f1 (or frequency band #1) is forwarded between a primary UE and the collaborative UE by using frequency f2 (or frequency band #2). However, the data forwarding operation of the collaborative UE for the primary UE may increase the total power consumption. In addition, not only is the desired signal transmitted, but the interference may also be passed to the network node in the data forwarding process.

Accordingly, how to optimize the overall performance of the data forwarding operation is an important issue for the newly developed wireless communication network.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to the on-off control of the data forwarding operation of a collaborative UE in mobile communications.

In one aspect, a method may involve an apparatus transmitting at least one configuration parameter to a collaborative device. The configuration parameter may be transmitted to the collaborative device to determine a time to activate a data forwarding operation of the collaborative device. The method may also involve the apparatus transmitting a first RF signal in a first frequency band to a network node according to the configuration parameter. The method may also involve the apparatus transmitting a second RF signal in a second frequency band to the collaborative device in an event that the data forwarding operation of the collaborative device is activated. The first RF signal and the second RF signal may carry uplink data to be transmitted to the network node, and the first frequency band may be different from the second frequency band.

In one aspect, a method may involve a collaborative device receiving at least one configuration parameter from an apparatus or a network node. The method may also involve the collaborative device determining a time to activate a data forwarding operation according to the configuration parameter. The method may also involve the collaborative device forwarding data from the apparatus to the network node in an event that the data forwarding operation is activated.

In one aspect, a method may involve an apparatus transmitting an indication to activate a data forwarding operation of a collaborative device. The method may also involve the apparatus transmitting a first RF signal in a first frequency band to a network node. The method may also involve the apparatus transmitting a second RF signal in a second frequency band to the collaborative device. The first RF signal and the second RF signal may carry uplink data to be transmitted to the network node, and the first frequency band may be different from the second frequency band.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the first aspect of the present disclosure.

FIG. 3 is a diagram depicting another example scenario under schemes in accordance with implementations of the first aspect of the present disclosure.

FIG. 4 is a diagram depicting an example scenario under schemes in accordance with implementations of the second aspect of the present disclosure.

FIG. 5 is a diagram depicting an example communication system having an example communication apparatus, an example network apparatus and an example collaborative apparatus in accordance with an implementation of the present disclosure.

FIG. 6 is a diagram depicting an example process in accordance with an implementation of the present disclosure.

FIG. 7 is a diagram depicting another example process in accordance with an implementation of the present disclosure.

FIG. 8 is a diagram depicting another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### OVERVIEW

Implementations in accordance with the present disclosure relate to various techniques, methods, schemes and/or solutions pertaining to on-off control of data forwarding operation of the collaborative UE in mobile communications. According to the present disclosure, a number of possible solutions may be implemented separately or jointly. That is, although these possible solutions may be described below separately, two or more of these possible solutions may be implemented in one combination or another.

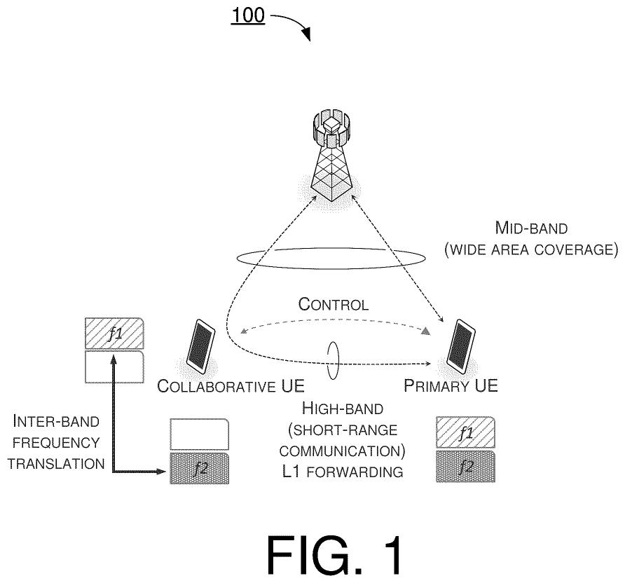

FIG. 1 illustrates an example scenario 100 under schemes in accordance with implementations of the present disclosure. Scenario 100 involves at least a primary UE, a collaborative UE and a network node, which may be a part of a wireless communication network (e.g., an LTE network, a 5G/NR network, an IoT network or a 6G network). Scenario 100 illustrates the framework of data forwarding operation in a communication system. The primary UE may expand its MIMO capability (e.g., effective number of MIMO layers) by using data forwarding via the collaborative UE. Specifically, the primary UE may directly communicate with the network node (e.g., gNB) on a first frequency f1 (or in a first frequency band #1, for example, in a licensed band). The first frequency f1 may comprise a mid-band frequency (e.g., frequency range 1 (FR1)) which has wide area coverage and is suitable for long-range communication. In addition to the direct communication with the network node, the primary UE may establish an indirect communication with the network node via the collaborative UE. The collaborative UE may communicate with the primary UE on a second frequency f2 (or in a second frequency band #2, for example, in an unlicensed band). The second frequency f2 may comprise a high-band frequency (e.g., frequency range 2 (FR2)), which has a high data rate and is suitable for short-range communication. For long-range communication, the collaborative UE may also communicate with the network node in the first frequency f1 (or in a first frequency band #1). Thus, the collaborative UE may perform an inter-band frequency translation or conversion to translate or shift the first frequency f1 in the first frequency band #1 into the second frequency f2 in the second frequency band #2 or translate or shift the second frequency f2 in the second frequency band #2 into the first frequency f1 in the first frequency band #1. The collaborative UE may help forward the data transmission between the primary UE and the network node. The data forwarding performed by the collaborative UE may comprise the layer 1 (L1) forwarding and/or the layer 2 (L2) forwarding. For example, the collaborative UE may perform amplify-and-forward with frequency translation between band #1 and band #2 with nearly zero latency. It should be noted that the first frequency band and the second frequency band here mean two non-overlapped frequency resources, and they are not limited to be in two different “bands” specifically defined by organizations like International Telecommunication Union (ITU) or 3rd Generation Partnership Project (3GPP). For example, they can be two nonoverlapped component carriers with non-overlapped frequency resources within one band (e.g., band n78) defined by 3GPP for 5G NR.

However, the data forwarding operation for the primary UE inevitably leads to power consumption in the collaborative UE. In addition, not only is the desired signal (e.g., the Uu interface data) transmitted, but unwanted interference may also be passed to the network node in the data forwarding process. For example, the primary UE may perform a Listen Before Talk (LBT) procedure before transmitting in the unlicensed band, which introduces a level of uncertainty in transmission over the link between the primary UE and the collaborative UE since the result of the LBT procedure is transparent to the collaborative UE. When the primary UE detects that the communication channel is occupied by other devices, it refrains from transmitting signals or data to the collaborative UE. However, the collaborative UE, unaware of this, still receives signals from other devices, which are considered unwanted interference. Consequently, the collaborative UE may inadvertently pass this interference to the network node.

To mitigate the forwarding of unwanted interference, the collaborative UE may be dynamically and intelligently switched to an off state when the primary UE isn't transmitting a signal, thereby preventing the forwarding of interference during the periods when no desired signal has to be forwarded.

In view of the above, the present disclosure proposes some schemes pertaining to efficient on-off control or management of the data forwarding operation of the collaborative UE in mobile communications, for example, efficient on-off control of the data forwarding operation performed on the unlicensed band. In some implementations, the collaborative UE may operate in an on state or an off state. The default operational state of the collaborative UE may be off. When operating in the on state, the data forwarding operation is activated, and when operating in the off state, the data forwarding operation is deactivated.

According to the schemes of the present disclosure, the data forwarding operation of the collaborative UE may be controlled based on the configuration associated with the primary UE, and the control of the on or off state of the data forwarding operation may be performed by the primary UE or the collaborative UE.

In a first aspect of the present disclosure, the activation and deactivation of the data forwarding operation (i.e., the on-off control of the data forwarding operation) may be determined by the collaborative UE. The collaborative UE may acquire the necessary information to predict the timing of uplink transmissions (for example, the signal or data transmissions) that are supposed to be forwarded. The collaborative UE may decode control information that indicates the timing of uplink transmissions that are supposed to be forwarded. The collaborative UE's behavior, including the control of its on or off state, may be adjusted based on the acquired information. For example, the data forwarding operation may be activated or deactivated dynamically according to the uplink transmission requirement or the uplink transmission timing of the primary UE. Accordingly, undesired interference will not be passed to the network node and the power consumption of the collaborative UE can be reduced as well.

More specifically, from the collaborative UE's perspective, the collaborative UE may acquire at least one configuration parameter associated with the primary UE. The configuration parameter may indicate (either implicitly or explicitly) or may be related to the scheduling of uplink transmission of the primary UE. The collaborative UE may receive the configuration parameter from the primary UE or the network node.

The collaborative UE may determine a time to activate the data forwarding operation according to the configuration parameter. In an event that the data forwarding operation is activated, the collaborative UE may forward data from the primary UE to the network node, such as the indirect communication between the primary UE and the network node, as illustrated in FIG. 1.

Specifically, in the data forwarding operation, the collaborative UE may receive a first RF signal from the primary UE and transmit a second RF signal to the network node. The first RF signal and the second RF signal may both carry uplink data of the primary UE to be transmitted to the network node. The second RF signal may be transmitted in a first frequency band and the first RF signal may be received in a second frequency band, and the first frequency band may be different from the second frequency band. In some implementations, the first RF signal and the second RF signal may carry the same uplink data to be transmitted to the network node. Therefore, the collaborative UE may help to forward the uplink data of the primary UE to the network node.

In some implementations, the configuration parameter may comprise at least one of a sounding reference signal (SRS) configuration, a physical downlink control channel (PDCCH) configuration, and a configured grant parameter for a physical uplink shared channel (PUSCH).

With the SRS configuration, the collaborative UE may determine the SRS transmission timing of the primary UE. The collaborative UE may know or understand the SRS transmission configurations assigned to the primary UE, such as the time-frequency locations within a slot and the periodicity of the SRS transmissions. This information helps the collaborative UE to anticipate when SRS transmissions will occur.

With the configured grant parameter for the PUSCH, the collaborative UE may determine the data transmission timing of the primary UE on the configured grant-based PUSCH.

In some implementations, the collaborative UE may determine an uplink transmission timing of the primary UE according to the SRS transmission timing and/or the data transmission timing and determine the time to activate the data forwarding operation according to the uplink transmission timing.

In some implementations, with the PDCCH configuration, the collaborative UE may derive or determine the time-frequency resource of control information (e.g., the uplink grant Downlink Control Information (DCI) indication) transmitted by the network node. The timing of data transmissions may be indicated by the network node via the control information (e.g., the uplink grant DCI), which may provide specific timing details to the primary UE.

The collaborative UE may further receive at least one decoding parameter associated with the primary UE from the primary UE or the network node. The decoding parameter may comprise at least one of a radio network temporary identifier (RNTI), a control resource set (CORESET) and a search space associated with the primary UE.

The collaborative UE may monitor and receive the control information (which may be presented as a control signal) intended for the primary UE from the network node according to the configuration parameter, such as the PDCCH settings configured for the primary UE, and decode the control information (i.e., the control signal) according to the decoding parameter. In some implementations, the control signal may comprise the DCI for uplink grant or a group-based DCI for uplink grant (i.e., DCI-based group scheduling or group scheduling via DCI). The group-based DCI may indicate the timing of data transmission allocated to the primary UE.

After decoding the control signal, the collaborative UE may determine an uplink transmission timing of the primary UE according to the content of the control signal and determine the time to activate the data forwarding operation according to the uplink transmission timing.

The monitoring, receiving and/or decoding of the control signal may be performed in an assistant mode. The collaborative UE may receive a trigger signal from the primary UE to initiate the assistant mode and receive a termination signal from the primary UE to terminate the assistant mode.

In some implementations, the data forwarding operation may be activated in the assistant mode. In the assistant mode and before activating the data forwarding operation or before switching from the off state to the on state, the collaborative UE may further perform channel sensing based on a duration and a power threshold criterion to determine whether a communication channel between the collaborative UE and the primary UE is available.

In an event that the communication channel is determined to be available, the collaborative UE may determine to activate the data forwarding operation or switch to the on state. In an event that the communication channel is determined to be unavailable, the collaborative UE may determine not to activate the data forwarding operation or stay in the off state.

From the primary UE's perspective, the primary UE may transmit at least one configuration parameter associated with the primary UE to the collaborative UE, to assist the collaborative UE in determining a time to activate the data forwarding operation. The configuration parameter may comprise at least one of an SRS configuration, a PDCCH configuration, and a configured grant parameter for a PUSCH.

The primary UE may further transmit a first RF signal in the first frequency band to the network node according to the configuration parameter and transmit a second RF signal in the second frequency band which is different from the first frequency band to the collaborative UE in an event that the data forwarding operation of the collaborative UE is activated. In some implementations, the first RF signal and the second RF signal may both carry uplink data of the primary UE to be transmitted to the network node, and the uplink data carried in the first RF signal and the second RF signal may be the same.

The primary UE may further transmit a trigger signal to the collaborative UE to initiate an assistant mode of the collaborative UE and transmit a termination signal to the collaborative UE to terminate the assistant mode. In the assistant mode, the collaborative UE may monitor and receive the control signal intended for the primary UE.

The primary UE may further transmit a decoding parameter to the collaborative UE to assist the collaborative UE in decoding the control signal. The decoding parameter may comprise at least one of the RNTI, the CORESET and the search space associated with the primary UE, and the control signal may comprise a DCI for uplink grant or a group-based DCI for uplink grant.

In a second aspect of the present disclosure, the activation and deactivation of the data forwarding operation (i.e., the on-off control of the data forwarding operation) may be determined by the primary UE. The data forwarding operation may be activated or deactivated dynamically according to the uplink transmission requirement or the uplink transmission timing of the primary UE. Accordingly, undesired interference will not be passed to the network node, and the power consumption of the collaborative UE can be reduced as well.

From the primary UE's perspective, the primary UE may transmit an indication to activate the data forwarding operation of the collaborative UE. The indication may comprise information regarding a duration or a start time and an end time to activate the data forwarding operation. In some implementations, the information is determined according to at least one of the SRS configuration, the PDCCH configuration, a configured grant parameter for the PUSCH, the DCI for uplink grant, the group-based DCI for uplink grant and a channel occupancy time (COT) obtained by the primary UE.

The primary UE may transmit a first RF signal in a first frequency band to the network node and transmit a second RF signal in a second frequency band to the collaborative UE in an event that the data forwarding operation is activated. The first RF signal and the second RF signal may both carry uplink data of the primary UE to be transmitted to the network node, and the collaborative UE may forward the uplink data of the primary UE to the network node. In some implementations, the first RF signal and the second RF signal may carry the same uplink data to be transmitted to the network node, and the first frequency band may be different from the second frequency band.

In some implementations, the primary UE may perform channel sensing to determine whether a communication channel between the primary UE and the collaborative UE is available. For example, the primary UE may perform channel sensing (e.g., by performing the LBT procedure) before the next transmission (e.g., the PUSCH, PUCCH or SRS transmission) in the frequency band #2 starts and may get the COT when the communication channel is determined to be available in the LBT procedure. The indication may be transmitted to the collaborative UE in an event that the communication channel is determined to be available. In some implementations, in an event that the communication channel is determined to be available, the primary UE may further transmit dummy data in the second frequency band before transmitting the second RF signal and after getting the COT or after transmitting the indication.

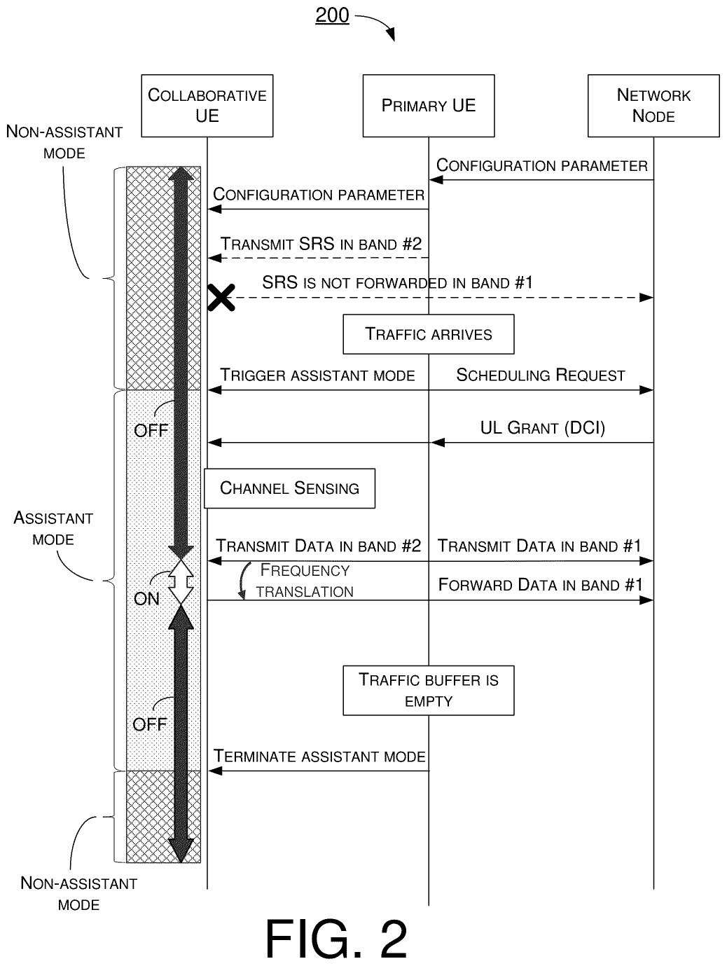

FIG. 2 illustrates an example scenario 200 under schemes in accordance with implementations of the first aspect of the present disclosure. The collaborative UE may operate in the non-assistant mode by default. In addition, the collaborative UE may operate in the off state (indicated by the black arrow extended along the vertical direction in FIG. 2) in which the data forwarding operation is not activated by default.

The primary UE may communicate with the collaborative UE via a wireless communication protocol, such as Wi-Fi or Bluetooth. The primary UE or the collaborative UE may perform a device discovery and association procedure to enable communication with each other.

After the communication between the primary UE and the collaborative UE has been established, the primary UE may receive at least one configuration parameter from the network node and transmit the configuration parameter to the collaborative UE. The configuration parameter may comprise at least one of an SRS configuration, a PDCCH configuration, and a configured grant parameter for a PUSCH.

In some implementations, the collaborative UE may also directly receive the configuration parameter from the network node. With the configuration parameter, the collaborative UE may acquire the uplink transmission time of the primary UE.

In some implementations, the collaborative UE may further receive at least one decoding parameter associated with the primary UE from the primary UE or the network node (not shown in FIG. 2). The decoding parameter may comprise at least one of an RNTI, a CORESET and a search space associated with the primary UE. The decoding parameter may be utilized in decoding the control information transmitted by the network node to the primary UE, and the collaborative UE may also acquire the uplink transmission time of the primary UE according to the decoding result.

The primary UE may transmit SRS in the frequency band #2 to the collaborative UE, and the SRS will be forwarded in the frequency band #1 to the network node in an event that the data forwarding operation is activated. In scenario 200, since the collaborative UE is not yet switched to the on state, the SRS is not forwarded in the frequency band #1.

In response to the traffic arrival, the primary UE may transmit a scheduling request to the network node when there is no available uplink resource and may also transmit a trigger signal to the collaborative UE to trigger or initiate the assistant mode.

The collaborative UE may operate in the assistant mode in response to the trigger signal. In the assistant mode, the collaborative UE may monitor the control information (such as the UL grant (DCI)) transmitted by the network node for the primary UE according to the configuration parameter (such as the PDCCH configuration) and decode the UL grant according to the decoding parameter. With the control information (e.g., the information of UL grant), the collaborative UE may acquire the data transmission time of the primary UE.

Based on the acquired information regarding the data transmission time of the primary UE, the collaborative UE may perform channel sensing for a duration before the time of any transmission of the primary UE. For example, the collaborative UE may perform channel sensing before switching to the on state (i.e., activating the data forwarding operation).

The collaborative UE may perform channel sensing based on a duration (e.g., a sensing duration) and a power threshold criterion to determine whether a communication channel between the collaborative UE and the primary UE is available. When a sensed power level is higher than the power threshold, the sensing may not be passed. The collaborative UE may consider that the measured channel is busy, and the primary UE may be unlikely to transmit one or more signals over the channel. Therefore, the communication channel may be determined as unavailable. The collaborative UE may determine not to activate the data forwarding operation and keep operating in the off state in an event that the communication channel is determined to be unavailable.

On the other hand, when the sensed power level is not higher than the power threshold, the sensing may be passed. The collaborative UE may consider that the measured channel is not busy, and the primary UE may transmit one or more signals over the channel. Therefore, the communication channel may be determined as available. The collaborative UE may determine to switch to the on state (indicated by the white arrow extended along the vertical direction in FIG. 2) and activate the data forwarding operation in the event that the communication channel is determined to be available.

The primary UE may transmit data in the frequency band #1 to the network node at the data transmission time indicated or configured by the network node and may transmit the data in the frequency band #2 to the collaborative UE. The collaborative UE may perform the inter-band frequency translation or conversion to translate or shift the data signal from the frequency band #2 to the frequency band #1 and transmit the data in the frequency band #1 to the network node. In this manner, the uplink signal or data received by the collaborative UE in the frequency band #2 from the primary UE is forwarded to the network node in the frequency band #1.

The collaborative UE may determine to switch to the off state and deactivate the data forwarding operation when the data forwarding operation is completed.

In addition, when determining that the traffic buffer is empty, the primary UE may transmit a termination signal to the collaborative UE to terminate the assistant mode.

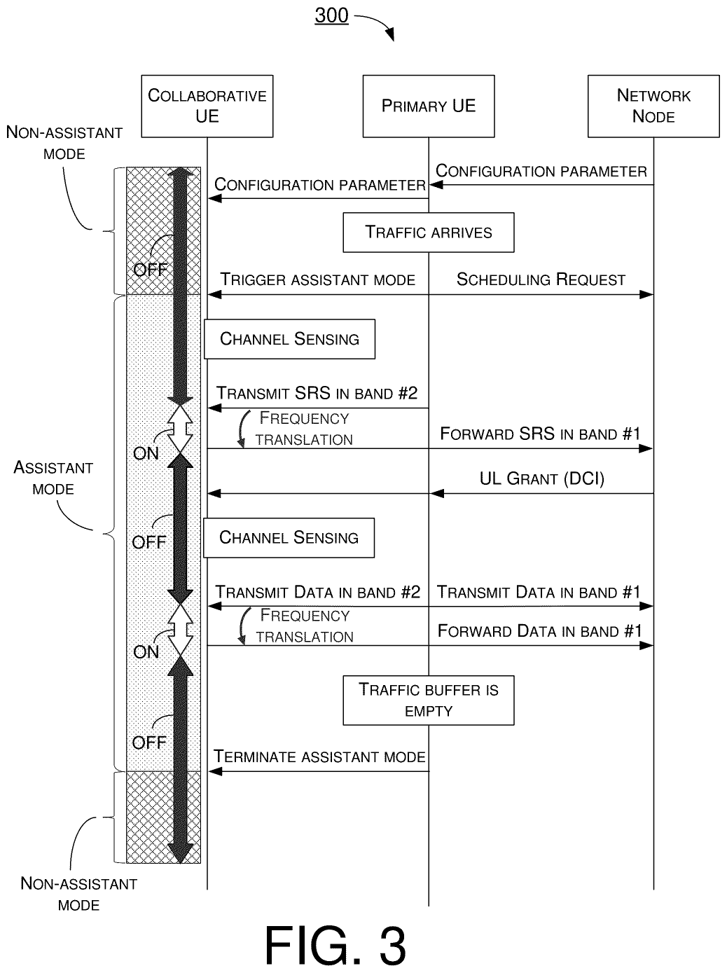

FIG. 3 illustrates another example scenario 300 under schemes in accordance with implementations of the first aspect of the present disclosure. The collaborative UE may operate in the non-assistant mode by default. In addition, the collaborative UE may operate in the off state (indicated by the black arrow extended along the vertical direction in FIG. 3) in which the data forwarding operation is not activated by default.

The primary UE may communicate with the collaborative UE via a wireless communication protocol, such as Wi-Fi or Bluetooth. The primary UE or the collaborative UE may perform a device discovery and association procedure to enable communication with each other.

After the communication between the primary UE and the collaborative UE has been established, the primary UE may receive at least one configuration parameter from the network node and transmit the configuration parameter to the collaborative UE. The configuration parameter may comprise at least one of an SRS configuration, a PDCCH configuration, and a configured grant parameter for a PUSCH.

In some implementations, the collaborative UE may also directly receive the configuration parameter from the network node. With the configuration parameter, the collaborative UE may acquire the uplink transmission time of the primary UE.

The collaborative UE may further receive at least one decoding parameter associated with the primary UE from the primary UE or the network node (not shown in FIG. 3). The decoding parameter may comprise at least one of an RNTI, a CORESET and a search space associated with the primary UE. The decoding parameter may be utilized in decoding the control information transmitted by the network node to the primary UE, and the collaborative UE may also acquire the uplink transmission time of the primary UE according to the decoding result.

In response to the traffic arrival, the primary UE may transmit a scheduling request to the network node when there is no available uplink resource and may also transmit a trigger signal to the collaborative UE to trigger or initiate the assistant mode.

The collaborative UE may perform channel sensing based on a duration (e.g., a sensing duration) and a power threshold criterion to determine whether a communication channel between the collaborative UE and the primary UE is available. When a sensed power level is higher than the power threshold, the sensing may not be passed. The collaborative UE may consider that the measured channel is busy and the primary UE may be unlikely to transmit one or more signals over the channel. Therefore, the communication channel may be determined as unavailable. The collaborative UE may determine not to activate the data forwarding operation and keep operating in the off state in the event that the communication channel is determined to be unavailable.

On the other hand, when the sensed power level is not higher than the power threshold, the sensing may be passed. The collaborative UE may consider that the measured channel is not busy, and the primary UE may transmit one or more signals over the channel. Therefore, the communication channel may be determined as available. The collaborative UE may determine to switch to the on state (indicated by the white arrow extended along the vertical direction in FIG. 3) and activate the data forwarding operation in an event that the communication channel is determined to be available.

The primary UE may transmit SRS in the frequency band #2 to the collaborative UE according to the SRS configuration, and the SRS will be forwarded in the frequency band #1 to the network node in an event that the data forwarding operation is activated. The collaborative UE may perform the inter-band frequency translation or conversion to translate or shift the SRS from the frequency band #2 to the frequency band #1 and transmit the SRS in the frequency band #1 to the network node. In this manner, the SRS received by the collaborative UE in the frequency band #2 from the primary UE is forwarded to the network node in the frequency band #1.

The collaborative UE may determine to switch to the off state and deactivate the data forwarding operation when the data forwarding operation for SRS is completed.

In the assistant mode, the collaborative UE may keep monitoring the control information (such as the UL grant (DCI)) transmitted by the network node for the primary UE according to the configuration parameter (such as the PDCCH configuration) and decode the UL grant according to the decoding parameter. With the control information (e.g., the information of UL grant), the collaborative UE may acquire the data transmission time of the primary UE.

Before switching back to the on state, the collaborative UE may perform channel sensing based on the duration (e.g., a sensing duration) and the power threshold criterion to determine whether the communication channel between the collaborative UE and the primary UE is available. The collaborative UE may determine to switch to the on state and activate the data forwarding operation in an event that the communication channel is determined to be available.

The primary UE may transmit data in the frequency band #1 to the network node at the data transmission time indicated or configured by the network node and may transmit the data in the frequency band #2 to the collaborative UE. The collaborative UE may perform the inter-band frequency translation or conversion to translate or shift the data signal from the frequency band #2 to the frequency band #1 and transmit the data in the frequency band #1 to the network node. In this manner, the uplink signal or data received by the collaborative UE in the frequency band #2 from the primary UE is forwarded to the network node in the frequency band #1.

The collaborative UE may determine to switch to the off state and deactivate the data forwarding operation when the data forwarding operation is completed.

In addition, when determining that the traffic buffer is empty, the primary UE may transmit a termination signal to the collaborative UE to terminate the assistant mode.

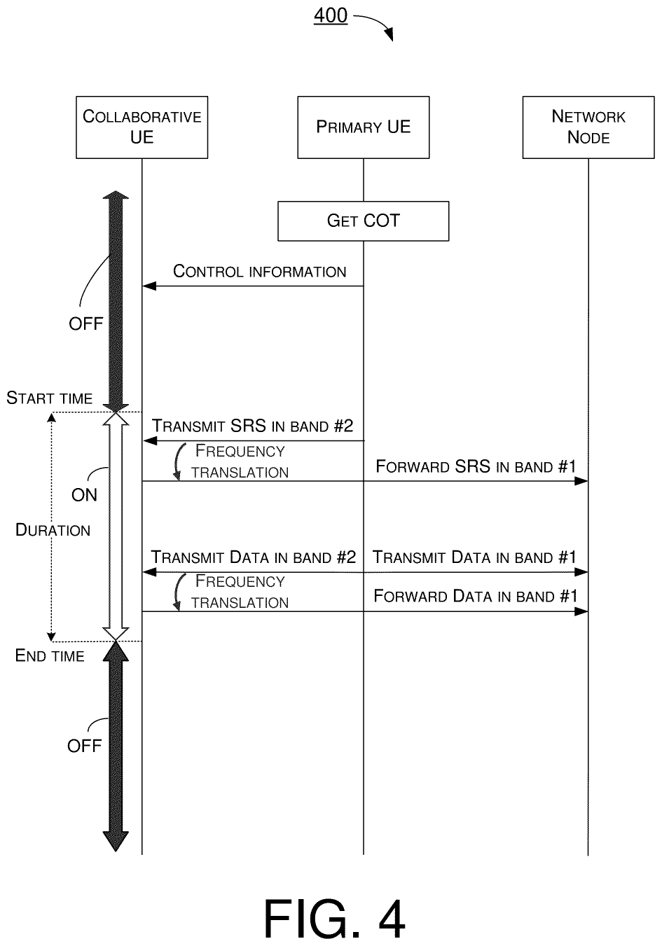

FIG. 4 illustrates another example scenario 400 under schemes in accordance with implementations of the second aspect of the present disclosure. The collaborative UE may operate in the off state (indicated by the black arrow extended along the vertical direction in FIG. 4) in which the data forwarding operation is not activated by default.

The primary UE may communicate with the collaborative UE via a wireless communication protocol, such as Wi-Fi or Bluetooth. The primary UE or the collaborative UE may perform a device discovery and association procedure to enable communication with each other.

The primary UE may perform channel sensing (e.g., by performing the LBT procedure) before the next transmission (e.g., the PUSCH, PUCCH or SRS transmission) in the frequency band #2 starts. The primary UE may get the COT when the communication channel is determined to be available.

The primary UE may determine a duration or a start time and an end time to activate the data forwarding operation of the collaborative UE and transmit an indication to the collaborative UE to activate the data forwarding operation after the primary UE gets the COT. In some implementations, the indication may comprise information (such as the control information as depicted in FIG. 4) regarding the duration or the start time and the end time to activate the data forwarding operation.

In some implementations, the start time may be the next transmission time and the duration may be the COT duration obtained by the primary UE. In some implementations, the control information may be determined according to at least one of the SRS configuration, the PDCCH configuration, the configured grant parameter for the PUSCH, the DCI for uplink grant and the group-based DCI for uplink grant. The control information may be provided optionally in an event that it has been provided previously and the duration is not changed.

In some implementations, the primary UE may transmit dummy data in the second frequency band #2 before transmitting a signal or data to be forwarded to the collaborative UE in an event that the communication channel is determined to be available. The primary UE may transmit dummy data until an uplink (e.g., an SRS or a PUSCH) transmission comes.

The collaborative UE may actively maintain its on state starting with the start time and may remain operational throughout the duration. When operating in the on state, the collaborative UE may receive SRS from the primary UE in the frequency band #2 and forward the SRS in the frequency band #1 to the network node. The collaborative UE may perform the inter-band frequency translation or conversion to translate or shift the SRS from the frequency band #2 to the frequency band #1 and transmit the SRS in the frequency band #1 to the network node.

In addition, the primary UE may transmit data in the frequency band #1 to the network node at the data transmission time indicated or configured by the network node and may transmit the data in the frequency band #2 to the collaborative UE. The collaborative UE may perform the inter-band frequency translation or conversion to translate or shift the data signal from the frequency band #2 to the frequency band #1 and transmit the data in the frequency band #1 to the network node. In this manner, the uplink signal or data received by the collaborative UE in the frequency band #2 from the primary UE is forwarded to the network node in the frequency band #1.

The collaborative UE may determine to switch to the off state and deactivate the data forwarding operation at the end time indicated by the primary UE or upon expiration of the duration.

To summarize, with the proposed schemes pertaining to efficient on-off control or management of the data forwarding operation of the collaborative UE in mobile communications, undesired interference will not be passed to the network node and the power consumption of the collaborative UE can be reduced as well.

### Illustrative Implementations

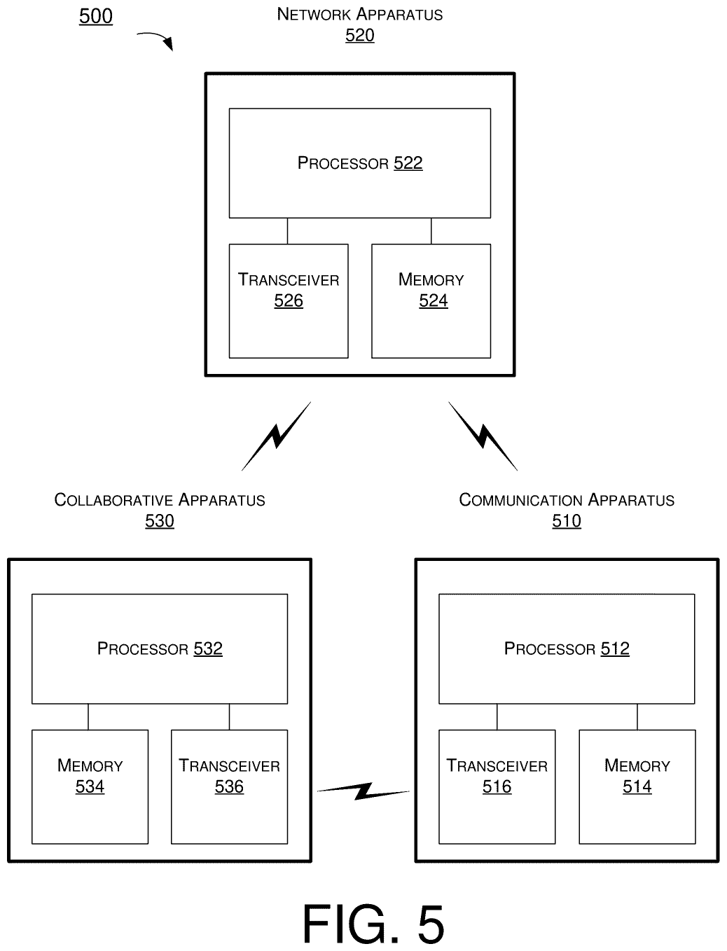

FIG. 5 illustrates an example communication system 500 having an example communication apparatus 510, an example network apparatus 520 and an example collaborative apparatus 530 in accordance with an implementation of the present disclosure. Each of the communication apparatus 510, the network apparatus 520 and the collaborative apparatus 530 may perform various functions to implement schemes, techniques, processes and methods described herein pertaining to on-off control or management of the data forwarding operation in mobile communications, including scenarios/schemes described above as well as the process 600, the process 700 and the process 800 described below.

The communication apparatus 510 may be a part of an electronic apparatus, which may be a UE such as a portable or mobile apparatus, a wearable apparatus, a wireless communication apparatus or a computing apparatus. For instance, the communication apparatus 510 may be implemented in a smartphone, a smartwatch, a personal digital assistant, a digital camera, or a computing equipment such as a tablet computer, a laptop computer or a notebook computer. The communication apparatus 510 may also be a part of a machine type apparatus, which may be an IoT, NB-IOT, or IIoT apparatus such as an immobile or a stationary apparatus, a home apparatus, a wire communication apparatus or a computing apparatus. For instance, the communication apparatus 510 may be implemented in a smart thermostat, a smart fridge, a smart door lock, a wireless speaker or a home control center. Alternatively, the communication apparatus 510 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. The communication apparatus 510 may include at least some of those components shown in FIG. 5 such as a processor 512, for example. The communication apparatus 510 may further include one or more other components not pertinent to the proposed scheme of the present disclosure (e.g., internal power supply, display device and/or user interface device), and, thus, such component(s) of the communication apparatus 510 are neither shown in FIG. 5 nor described below in the interest of simplicity and brevity.

The network apparatus 520 may be a part of a network device, which may be a network node such as a satellite, a BS, a gNB, a small cell, a router, or a gateway of a 4G/5G/B5G/6G, NR, IoT, NB-IOT or IIoT network. Alternatively, the network apparatus 520 may be implemented in the form of one or more IC chips such as, for example and without limitation, one or more single-core processors, one or more multi-core processors, or one or more RISC or CISC processors. The network apparatus 520 may include at least some of those components shown in FIG. 5 such as a processor 522, for example. The network apparatus 520 may further include one or more other components not pertinent to the proposed scheme of the present disclosure (e.g., internal power supply, display device and/or user interface device), and, thus, such component(s) of the network apparatus 520 are neither shown in FIG. 5 nor described below in the interest of simplicity and brevity.

The collaborative apparatus 530 may be a part of an electronic apparatus, which may be a UE such as a portable or mobile apparatus, a wearable apparatus, a wireless communication apparatus, a repeater, a relay device, a CPE or a computing apparatus. For instance, the collaborative apparatus 530 may be implemented in a smartphone, a smartwatch, an XR glasses, a personal digital assistant, a digital camera, or a computing equipment such as a tablet computer, a laptop computer or a notebook computer. The collaborative apparatus 530 may also be a part of a machine type apparatus, which may be an IoT, NB-IoT, or IIoT apparatus such as an immobile or a stationary apparatus, a home apparatus, a wire communication apparatus or a computing apparatus. For instance, the collaborative apparatus 530 may be implemented in a smart thermostat, a smart fridge, a smart door lock, a wireless speaker or a home control center. Alternatively, the collaborative apparatus 530 may be implemented in the form of one or more IC chips such as, for example and without limitation, one or more single-core processors, one or more multi-core processors, one or more RISC processors, or one or more CISC processors. The collaborative apparatus 530 may include at least some of those components shown in FIG. 5 such as a processor 532, for example. The collaborative apparatus 530 may further include one or more other components not pertinent to the proposed scheme of the present disclosure (e.g., internal power supply, display device and/or user interface device), and, thus, such component(s) of the collaborative apparatus 530 are neither shown in FIG. 5 nor described below in the interest of simplicity and brevity.

In some implementations, the communication apparatus 510 may be a primary communication apparatus, such as the aforementioned primary UE, and the collaborative apparatus 530 may be a collaborative communication apparatus, such as the aforementioned collaborative UE.

In one aspect, each of the processor 512, the processor 522 and the processor 532 may be implemented in the form of one or more single-core processors, one or more multi-core processors, or one or more CISC processors. That is, even though a singular term “a processor” is used herein to refer to the processor 512, the processor 522 and the processor 532, each of the processor 512, the processor 522 and the processor 532 may include multiple processors in some implementations and a single processor in other implementations in accordance with the present disclosure. In another aspect, each of the processor 512, the processor 522 and the processor 532 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of the processor 512, the processor 522 and the processor 532 is a special-purpose machine specifically designed, arranged and configured to perform specific tasks in accordance with various implementations of the present disclosure.

In some implementations, the communication apparatus 510 may also include a transceiver 516 coupled to the processor 512 and capable of wirelessly transmitting and receiving data. In some implementations, the transceiver 516 may be capable of wirelessly communicating with different types of UEs and/or wireless networks of different RATs. In some implementations, the transceiver 516 may be equipped with a plurality of antenna ports (not shown) such as, for example, four antenna ports. That is, the transceiver 516 may be equipped with multiple transmit antennas and multiple receive antennas for MIMO wireless communications. In some implementations, the network apparatus 520 may also include a transceiver 526 coupled to the processor 522 and capable of wirelessly transmitting and receiving data. In some implementations, the transceiver 526 may be capable of wirelessly communicating with different types of UEs of different RATs. In some implementations, the transceiver 526 may be equipped with a plurality of antenna ports (not shown) such as, for example, four antenna ports. That is, transceiver 526 may be equipped with multiple transmit antennas and multiple receive antennas for MIMO wireless communications. In some implementations, the collaborative apparatus 530 may also include a transceiver 536 coupled to the processor 532 and capable of wirelessly transmitting and receiving data. In some implementations, the transceiver 536 may be capable of wirelessly communicating with different types of UEs and/or wireless networks of different RATs. In some implementations, the transceiver 536 may be equipped with a plurality of antenna ports (not shown). That is, the transceiver 536 may be equipped with multiple transmit antennas and multiple receive antennas for MIMO wireless communications.

In some implementations, the communication apparatus 510 may further include a memory 514 coupled to the processor 512 and capable of being accessed by the processor 512 and storing data therein. In some implementations, the network apparatus 520 may further include a memory 524 coupled to the processor 522 and capable of being accessed by the processor 522 and storing data therein. In some implementations, the collaborative apparatus 530 may further include a memory 534 coupled to the processor 532 and capable of being accessed by the processor 532 and storing data therein. Each of the memory 514, the memory 524 and the memory 534 may include a type of random-access memory (RAM) such as dynamic RAM (DRAM), static RAM (SRAM), thyristor RAM (T-RAM) and/or zero-capacitor RAM (Z-RAM). Alternatively, or additionally, each of the memory 514, the memory 524 and the memory 534 may include a type of read-only memory (ROM) such as mask ROM, programmable ROM (PROM), erasable programmable ROM (EPROM) and/or electrically erasable programmable ROM (EEPROM). Alternatively, or additionally, each of the memory 514, the memory 524 and the memory 534 may include a type of non-volatile random-access memory (NVRAM) such as flash memory, solid-state memory, ferroelectric RAM (FeRAM), magnetoresistive RAM (MRAM) and/or phase-change memory.

Accordingly, the communication apparatus 510, the network apparatus 520 and the collaborative apparatus 530 may wirelessly communicate with each other via the transceiver 516, the transceiver 526 and the transceiver 536, respectively. To aid better understanding, the following description of the operations, functionalities and capabilities of each of the communication apparatus 510, the network apparatus 520 and the collaborative apparatus 530 is provided in the context of a mobile communication environment in which the communication apparatus 510 is implemented in or as a primary communication apparatus or a primary UE, the network apparatus 520 is implemented in or as a network node or a network device and the collaborative apparatus 530 is implemented in or as a collaborative communication apparatus, a collaborative device or a collaborative UE of a communication network supporting device collaborative communications.

Each of the communication apparatus 510, the network apparatus 520 and the collaborative apparatus 530 may be a communication entity capable of communicating with each other using various proposed schemes in accordance with the present disclosure. For illustrative purposes and without limitation, a description of capabilities of the communication apparatus 510, as a primary UE, the network apparatus 520, as a network node, and the collaborative apparatus 530, as a collaborative UE, is provided below with the process 600, the process 700 and the process 800.

### Illustrative Processes

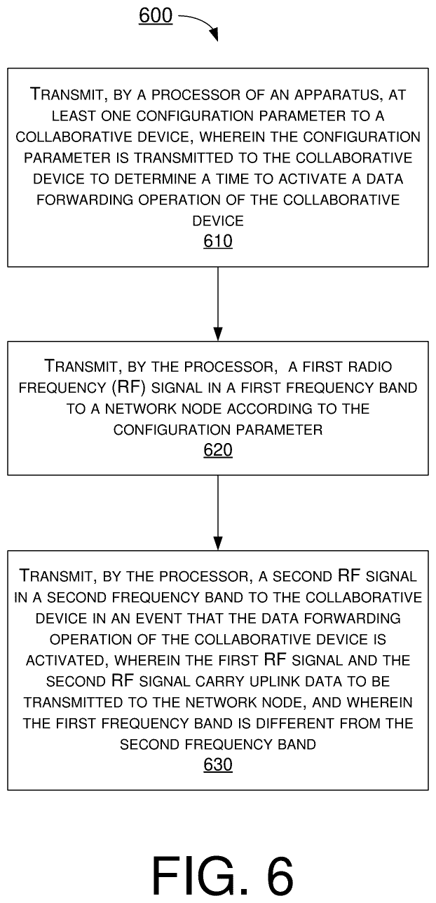

FIG. 6 illustrates an example process 600 in accordance with an implementation of the present disclosure. The process 600 may be an example implementation of above scenarios/schemes, whether partially or completely, including those described above with respect to on-off control or management of the data forwarding operation in mobile communications. The process 600 may represent an aspect of implementation of features of the communication apparatus 510. The process 600 may include one or more operations, actions, or functions as illustrated by one or more of blocks 610, 620 and 630. Although illustrated as discrete blocks, various blocks of the process 600 may be divided into additional blocks, combined into fewer blocks, or eliminated, depending on the desired implementation. Moreover, the blocks of the process 600 may be executed in the order shown in FIG. 6 or, alternatively, in a different order. The process 600 may be implemented by or in the communication apparatus 510 or any suitable UE or machine type device. Solely for illustrative purposes and without limiting the scope, the process 600 is described below in the context of the communication apparatus 510, as a primary UE, the network apparatus 520, as a network node (e.g., a BS) and the collaborative apparatus 530, as a collaborative device or a collaborative UE. Process 600 may begin at block 610.

At block 610, the process 600 may involve the processor 512 of the communication apparatus 510 transmitting at least one configuration parameter to the collaborative apparatus 530. The configuration parameter may be transmitted to the collaborative apparatus 530 to determine a time to activate a data forwarding operation of the collaborative apparatus 530. The process 600 may proceed from block 610 to block 620.

At block 620, the process 600 may involve the processor 512 transmitting a first RF signal in a first frequency band to the network apparatus 520 according to the configuration parameter. The process 600 may proceed from block 620 to block 630.

At block 630, the process 600 may involve the processor 512 transmitting a second RF signal in a second frequency band to the collaborative apparatus 530 in an event that the data forwarding operation of the collaborative apparatus 530 is activated. In some implementations, the first RF signal and the second RF signal may carry uplink data to be transmitted to the network node, and the first frequency band may be different from the second frequency band.

In some implementations, the configuration parameter may comprise at least one of an SRS configuration, a PDCCH configuration, and a configured grant parameter for a PUSCH.

In some implementations, the process 600 may further involve the processor 512 transmitting a trigger signal to the collaborative apparatus 530 to initiate an assistant mode of the collaborative apparatus 530. A control signal may be received by the collaborative apparatus 530 in the assistant mode.

In some implementations, the process 600 may further involve the processor 512 transmitting a termination signal to the collaborative apparatus 530 to terminate the assistant mode of the collaborative apparatus 530.

In some implementations, the process 600 may further involve the processor 512 transmitting a decoding parameter to the collaborative apparatus 530. The decoding parameter may comprise at least one of an RNTI, a CORESET and a search space associated with the communication apparatus 510. The control signal may be decoded by the collaborative apparatus 530 according to the decoding parameter.

In some implementations, the control signal may comprise a DCI for uplink grant or a group-based DCI for uplink grant.

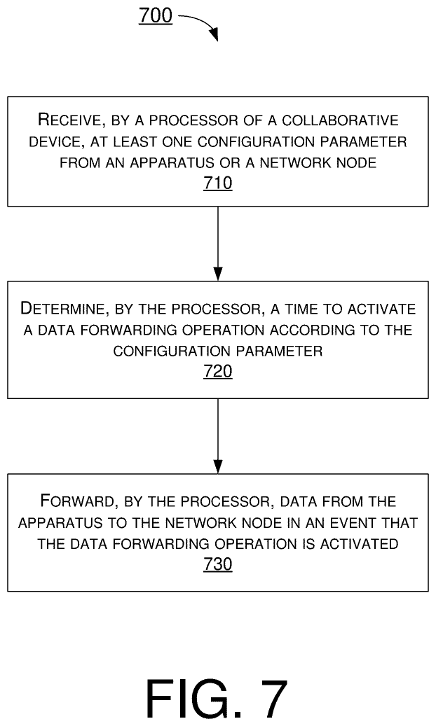

FIG. 7 illustrates an example process 700 in accordance with an implementation of the present disclosure. The process 700 may be an example implementation of above scenarios/schemes, whether partially or completely, including those described above with respect to on-off control or management of the data forwarding operation in mobile communications. The process 700 may represent an aspect of implementation of features of the collaborative apparatus 530. The process 700 may include one or more operations, actions, or functions as illustrated by one or more of blocks 710, 720 and 730. Although illustrated as discrete blocks, various blocks of the process 700 may be divided into additional blocks, combined into fewer blocks, or eliminated, depending on the desired implementation. Moreover, the blocks of the process 700 may be executed in the order shown in FIG. 7 or, alternatively, in a different order. The process 700 may be implemented by or in the collaborative apparatus 530 or any suitable UE or machine type device. Solely for illustrative purposes and without limiting the scope, the process 700 is described below in the context of the communication apparatus 510, as a primary UE, the network apparatus 520, as a network node (e.g., a BS) and the collaborative apparatus 530, as a collaborative device or a collaborative UE. Process 700 may begin at block 710.

At block 710, the process 700 may involve the processor 532 of the collaborative apparatus 530 receiving at least one configuration parameter from the communication apparatus 510 or the network apparatus 520. The process 700 may proceed from block 710 to block 720.

At block 720, the process 700 may involve the processor 532 determining a time to activate a data forwarding operation according to the configuration parameter. The process 700 may proceed from block 720 to block 730.

At block 730, the process 700 may involve the processor 532 forwarding data from the communication apparatus 510 to the network apparatus 520 in an event that the data forwarding operation is activated.

In some implementations, the configuration parameter may comprise at least one of an SRS configuration, a PDCCH configuration, and a configured grant parameter for a PUSCH.

In some implementations, the process 700 may further involve the processor 532 receiving a decoding parameter from the communication apparatus 510 or the network apparatus 520. The decoding parameter may comprise at least one of an RNTI, a CORESET and a search space associated with the communication apparatus 510.

In some implementations, the process 700 may further involve the processor 532 receiving a control signal from the network apparatus 520 according to the configuration parameter and decoding the control signal according to the decoding parameter.

In some implementations, the process 700 may further involve the processor 532 determining an uplink transmission timing of the communication apparatus 510 according to the control signal. The time to activate the data forwarding operation may be determined further according to the uplink transmission timing.

In some implementations, the control signal may comprise a DCI for uplink grant or a group-based DCI for uplink grant.

In some implementations, the process 700 may further involve the processor 532 receiving a trigger signal from the communication apparatus 510 to initiate an assistant mode. The receiving and decoding of the control signal may be performed in the assistant mode. The process 700 may further involve the processor 532 receiving a termination signal from the communication apparatus 510 to terminate the assistant mode.

In some implementations, in the forwarding of the data from the communication apparatus 510 to the network apparatus 520, the process 700 may further involve the processor 532 receiving a first RF signal from the communication apparatus 510 and transmitting a second RF signal to the network apparatus 520. The first RF signal and the second RF signal may carry uplink data to be transmitted to the network apparatus 520. The second RF signal may be transmitted in a first frequency band and the first RF signal may be received in a second frequency band, and the first frequency band may be different from the second frequency band.

In some implementations, the process 700 may further involve the processor 532 performing channel sensing based on a duration and a power threshold criterion to determine whether a communication channel between the collaborative apparatus 530 and the communication apparatus 510 is available and activating the data forwarding operation in an event that the communication channel is determined to be available.

In some implementations, the process 700 may further involve the processor 532 determining not to activate the data forwarding operation in the event that the communication channel is determined to be unavailable.

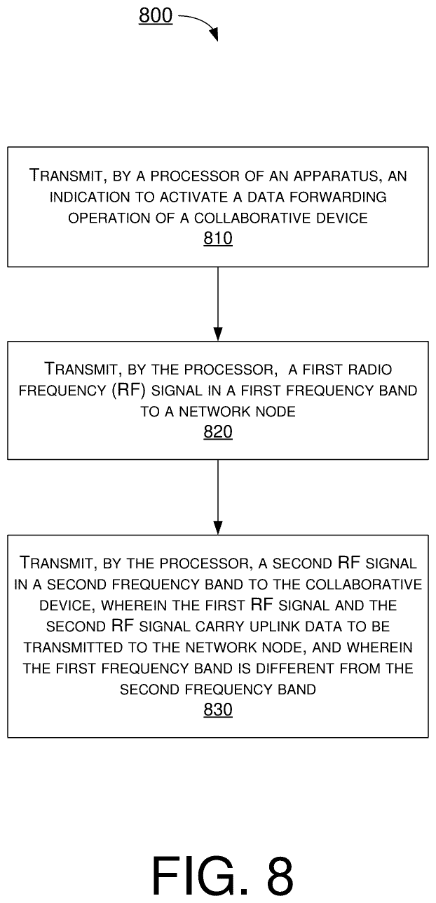

FIG. 8 illustrates an example process 800 in accordance with an implementation of the present disclosure. The process 800 may be an example implementation of above scenarios/schemes, whether partially or completely, including those described above with respect to on-off control or management of the data forwarding operation in mobile communications. The process 800 may represent an aspect of implementation of features of the communication apparatus 510. The process 800 may include one or more operations, actions, or functions as illustrated by one or more of blocks 810, 820 and 830. Although illustrated as discrete blocks, various blocks of the process 800 may be divided into additional blocks, combined into fewer blocks, or eliminated, depending on the desired implementation. Moreover, the blocks of the process 800 may be executed in the order shown in FIG. 8 or, alternatively, in a different order. The process 800 may be implemented by or in the communication apparatus 510 or any suitable UE or machine type device. Solely for illustrative purposes and without limiting the scope, the process 800 is described below in the context of the communication apparatus 510, as a primary UE, the network apparatus 520, as a network node (e.g., a BS) and the collaborative apparatus 530, as a collaborative device or a collaborative UE. Process 800 may begin at block 810.

At block 810, the process 800 may involve the processor 512 of the communication apparatus 510 transmitting an indication to activate a data forwarding operation of the collaborative apparatus 530. The process 800 may proceed from block 810 to block 820.

At block 820, the process 800 may involve the processor 512 transmitting a first RF signal in a first frequency band to the network apparatus 520. The process 800 may proceed from block 820 to block 830.

At block 830, the process 800 may involve the processor 512 transmitting a second RF signal in a second frequency band to the collaborative apparatus 530. The first RF signal and the second RF signal may carry uplink data to be transmitted to the network apparatus 520, and the first frequency band may be different from the second frequency band.

In some implementations, the indication may comprise information regarding a duration or a start time and an end time to activate the data forwarding operation.

In some implementations, the configuration parameter may comprise at least one of an SRS configuration, a PDCCH configuration, a configured grant parameter for a PUSCH, a DCI for uplink grant, a group-based DCI for uplink grant and a COT.

In some implementations, the process 800 may further involve the processor 512 performing channel sensing to determine whether a communication channel between the collaborative apparatus 530 and the communication apparatus 510 is available. The indication may be transmitted to the collaborative apparatus 530 in an event that the communication channel is determined to be available. The process 800 may further involve the processor 512 transmitting dummy data in the second frequency band before transmitting the second RF signal in an event that the communication channel is determined to be available.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
transmitting, by a processor of an apparatus, at least one configuration parameter to a collaborative device, wherein the configuration parameter is transmitted to the collaborative device to determine a time to activate a data forwarding operation of the collaborative device;
transmitting, by the processor, a first radio frequency (RF) signal in a first frequency band to a network node according to the configuration parameter; and
transmitting, by the processor, a second RF signal in a second frequency band to the collaborative device in an event that the data forwarding operation of the collaborative device is activated,
wherein the first RF signal and the second RF signal carry uplink data to be transmitted to the network node, and the first frequency band is different from the second frequency band.

2. The method of claim 1, wherein the configuration parameter comprises at least one of a sounding reference signal (SRS) configuration, a physical downlink control channel (PDCCH) configuration, and a configured grant parameter for a physical uplink shared channel (PUSCH).

3. The method of claim 1, further comprising:
transmitting, by the processor, a trigger signal to the collaborative device to initiate an assistant mode of the collaborative device, wherein a control signal is received by the collaborative device in the assistant mode.

4. The method of claim 3, further comprising:
transmitting, by the processor, a termination signal to the collaborative device to terminate the assistant mode of the collaborative device.

5. The method of claim 3, further comprising:
transmitting, by the processor, a decoding parameter to the collaborative device,
wherein the decoding parameter comprises at least one of a radio network temporary identifier (RNTI), a control resource set (CORESET) and a search space associated with the apparatus, and
wherein the control signal is decoded by the collaborative device according to the decoding parameter.

6. The method of claim 5, wherein the control signal comprises a downlink control information (DCI) for uplink grant or a group-based DCI for uplink grant.

7. A method, comprising:
receiving, by a processor of a collaborative device, at least one configuration parameter from an apparatus or a network node;
determining, by the processor, a time to activate a data forwarding operation according to the configuration parameter; and
forwarding, by the processor, data from the apparatus to the network node in an event that the data forwarding operation is activated.

8. The method of claim 7, wherein the configuration parameter comprises at least one of a sounding reference signal (SRS) configuration, a physical downlink control channel (PDCCH) configuration, and a configured grant parameter for a physical uplink shared channel (PUSCH).

9. The method of claim 7, further comprising:
receiving, by the processor, a decoding parameter from the apparatus or the network node,
wherein the decoding parameter comprises at least one of a radio network temporary identifier (RNTI), a control resource set (CORESET) and a search space associated with the apparatus.

10. The method of claim 9, further comprising:
receiving, by the processor, a control signal from the network node according to the configuration parameter; and
decoding, by the processor, the control signal according to the decoding parameter.

11. The method of claim 10, further comprising:
determining, by the processor, an uplink transmission timing of the apparatus according to the control signal,
wherein the time to activate the data forwarding operation is determined further according to the uplink transmission timing.

12. The method of claim 10, wherein the control signal comprises a downlink control information (DCI) for uplink grant or a group-based DCI for uplink grant.

13. The method of claim 10, further comprising:
receiving, by the processor, a trigger signal from the apparatus to initiate an assistant mode, wherein receiving and decoding of the control signal is performed in the assistant mode; and
receiving, by the processor, a termination signal from the apparatus to terminate the assistant mode.

14. The method of claim 7, wherein the forwarding of the data from the apparatus to the network node comprises:
receiving, by the processor, a first radio frequency (RF) signal from the apparatus; and
transmitting, by the processor, a second RF signal to the network node,
wherein the first RF signal and the second RF signal carry uplink data to be transmitted to the network node, the second RF signal is transmitted in a first frequency band and the first RF signal is received in a second frequency band, and the first frequency band is different from the second frequency band.

15. The method of claim 7, further comprising:
performing, by the processor, channel sensing based on a duration and a power threshold criterion to determine whether a communication channel between the collaborative device and the apparatus is available; and
activating, by the processor, the data forwarding operation in an event that the communication channel is determined to be available.

16. The method of claim 15, further comprising:
determining not to activate, by the processor, the data forwarding operation in an event that the communication channel is determined to be unavailable.

17. A method, comprising:
transmitting, by a processor of an apparatus, an indication to activate a data forwarding operation of a collaborative device;
transmitting, by the processor, a first radio frequency (RF) signal in a first frequency band to a network node; and
transmitting, by the processor, a second RF signal in a second frequency band to the collaborative device,
wherein the first RF signal and the second RF signal carry uplink data to be transmitted to the network node, and wherein the first frequency band is different from the second frequency band.

18. The method of claim 17, wherein the indication comprises information regarding a duration or a start time and an end time to activate the data forwarding operation.

19. The method of claim 18, wherein the information is determined according to at least one of a sounding reference signal (SRS) configuration, a physical downlink control channel (PDCCH) configuration, a configured grant parameter for a physical uplink shared channel (PUSCH), a downlink control information (DCI) for uplink grant, a group-based DCI for uplink grant and a channel occupancy time (COT).

20. The method of claim 17, further comprising:
performing, by the processor, channel sensing to determine whether a communication channel between the collaborative device and the apparatus is available, wherein the indication is transmitted to the collaborative device in an event that the communication channel is determined to be available; and
transmitting, by the processor, dummy data in the second frequency band before transmitting the second RF signal in an event that the communication channel is determined to be available.
